(19) United States
(12) Patent Application Publication
(10) Pub. No.: US 2018/0154761 A1
(43) Pub. Date: Jun. 7, 2018

(54) HUB MOTOR DESIGN

(71) Applicant: Timur Artemev, Haslemere, Surrey (GB)

(72) Inventor: Timur Artemev, Haslemere, Surrey (GB)

(21) Appl. No.: 15/577,720

(22) PCT Filed: May 27, 2016
(86) PCT No.: PCT/GB2016/051551

§ 371 Date: Nov. 28, 2017

(30) Foreign Application Priority Data
May 29, 2015 (GB) 1509324.8

(51) Int. Cl. B60K 7/00; B62K 11/00; B62K 1/00; H02K 5/04

(52) U.S. Cl. CPC B60K 7/0007; B62K 11/007; B62K 1/00; H02K 1/2786; B60K 2007/0038; B60K 2007/0092; H02K 5/04

(57) ABSTRACT

A powered unicycle device has a hub motor and a tyre around the motor. A motor casing around the motor defines side walls (300,305) and an outer annular rim (301,306), and the tyre is mounted around the outer annular rim (301,306). The motor casing is formed of only two side walls (300,305) each having a rim portion (301,305), and the rim portions (301,305) connect to each other, together defining the outer annular rim (301,305).

### FIELD OF INVENTION

The present invention relates to hub motors designs, for example for powered single-wheeled devices and more particularly to powered unicycles with self-balancing functionality.

### BACKGROUND TO THE INVENTION

Powered self-balancing vehicles for use while standing are known. Such vehicles include two-wheeled vehicles and single-wheeled vehicles (i.e. unicycles).

In a powered self-balancing unicycle, an electronic or mechanical system that controls the wheel in the appropriate direction is typically used to achieve fore-and-aft balance. This type of automatic fore-and-aft balance technology is well known and described, for example, in U.S. Pat. No. 6,302,230. A sensor and electronic equipment are typically provided. Information detected by the sensor and the electronics is relayed to a motor. The motor drives the wheel in the appropriate direction and at sufficient speed to maintain fore-and-aft balance.

The market for self-balancing unicycles of this type is strongly dependent on the weight of the product, which also influences the cost of manufacture of the device. There is therefore always a need to reduce production costs where possible.

One aspect is the number of different components that need to be manufactured to make the overall design.

### SUMMARY OF THE INVENTION

According to a first aspect of the invention, there is provided a hub motor for driving a wheel, wherein the hub motor comprises:
a motor casing around an inner part of the motor, wherein the casing defines side walls and an outer annular rim,
wherein the motor casing comprises a first side wall and a second side wall, each side wall comprising a rim portion, wherein the side walls are coupled together with the rim portions in contact with each other thereby together defining the outer annular rim.

There is thus provided a motor casing for a hub motor which is formed from only two casing parts or sub-assemblies, and these casing parts define both the side walls, which form the wheel hub, and a rim for example on which a tyre can be mounted. This provides a low component count and therefore reduces weight and thus manufacturing and assembly cost.

The hub motor for example has an inner stator and an outer rotor, and the outer rotor is mounted within the outer annular rim.

The first and second side walls are preferably identical in shape. In this way, there is a single component design for the two casing halves.

In one set of examples, each side wall comprises an integral side wall plate and rim portion. Thus, there are two identical individual components, which together define the side plates of the hub as well as the wheel rim.

In another set of examples, each side wall comprises a side wall plate and the rim portion, and the rim portion or a section of the rim portion is removable from the remainder of the side wall. In this design, the rim portion or a second if it can be separated. This enables easier tyre replacement, but without exposing the sealed motor cavity, which would result from fully dismantling the casing.

Different designs may be chosen either to optimise the ease of use, or else to reduce the weight, or number of components, or ease and cost of manufacture.

Preferably, two foot platforms are provided for supporting a user of the unicycle device. This is mounted on a non-rotating part of the device, for example coupled to the central stator.

In some embodiments, each side wall comprises a set of tabs around the inner periphery of the rim portion, the tabs being over an outer periphery of the outer rotor. These tabs provide fixing points. The side walls may be connected together at the tabs. The tabs provide strong connection points for fixing the casing parts together.

The outer rotor for example comprises a cylindrical carrier on which an array of permanent magnets is mounted. This carrier is sandwiched between the side walls. The carrier is made from a ferromagnetic material. The side walls then may be made of a lighter or lower cost material, for example aluminium. Alternatively, if the side walls are ferromagnetic, the magnets may be coupled directly to one or both side walls, avoiding the need for the carrier.

The hub motor for example has an inner stator which comprises an electromagnet coil arrangement. It is for example mounted around a fixed central axis about which the motor casing rotates.

The invention also provides a powered unicycle device, comprising:
a hub motor as defined above; and
a balance control system adapted to maintain fore-aft balance of the unicycle device.

A tyre is typically mounted around the annular outer rim. The hub motor forms a single wheel hub. There may however be two or more tyres mounted on the same hub.

### BRIEF DESCRIPTION OF THE DRAWINGS

An example of the invention will now be described with reference to the accompanying diagrams, in which:

FIG. 1 is an isometric view of an example of a powered unicycle device in a closed configuration;

FIG. 2 is an exploded diagram of components internal to the casing of FIG. 1,

FIGS. 3A & 3B are side and front elevations, respectively, of the example of FIG. 1, wherein the casing is moving between a closed and open configuration;

FIGS. 4A & 4B are side and front elevations, respectively, of the example of FIG. 1, wherein the casing is in an open configuration and the foot platforms are in a stowed configuration;

FIG. 5 is an exploded view of a basic design of motor casing;

FIG. 6 is an assembled view of the casing of FIG. 5;

FIG. 7 is an exploded view of an example of design of motor casing in accordance with the invention;

FIG. 8 shows the two casing side walls of the design of FIG. 7 together with the motor stator and the wheel, in exploded view;

FIG. 9 shows further views of the casing side walls in partially assembled form;

FIG. 10 shows the casing side walls in fully assembled form;

FIG. 11 shows in more detail how the rotor fits against a casing side wall; and

FIG. 12 shows how part of a casing side wall may be removed to facilitate wheel removal.

### DETAILED DESCRIPTION

The invention provides a hub motor, for example for use in a powered unicycle device in which there is a tyre around the hub motor. A motor casing around the motor defines side walls and an outer annular rim. The motor rotor is mounted within the outer annular rim. The motor casing is formed of only two side walls each having a rim portion, and the rim portions connect to each other, together defining the complete outer annular rim. When used in a powered unicycle device, the hub motor itself defines the wheel rim over which the tyre is mounted.

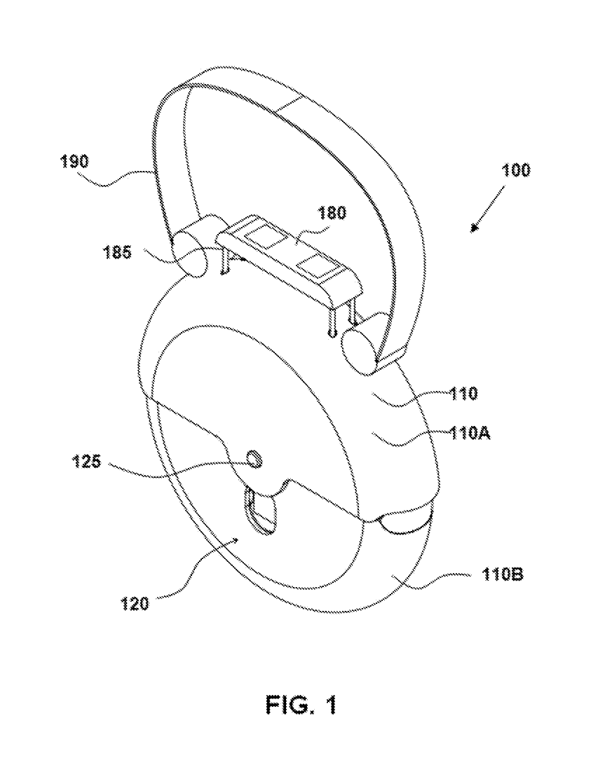

Before describing the motor casing arrangement of the invention, the operation of the general type of powered unicycle device is described with reference to FIGS. 1-4. These figures show a hubless design.

This invention is of particular interest for a hub motor design. However, a hubless design is first described in order to explain some of the possible features of the device, which may be employed in both hub and hubless designs.

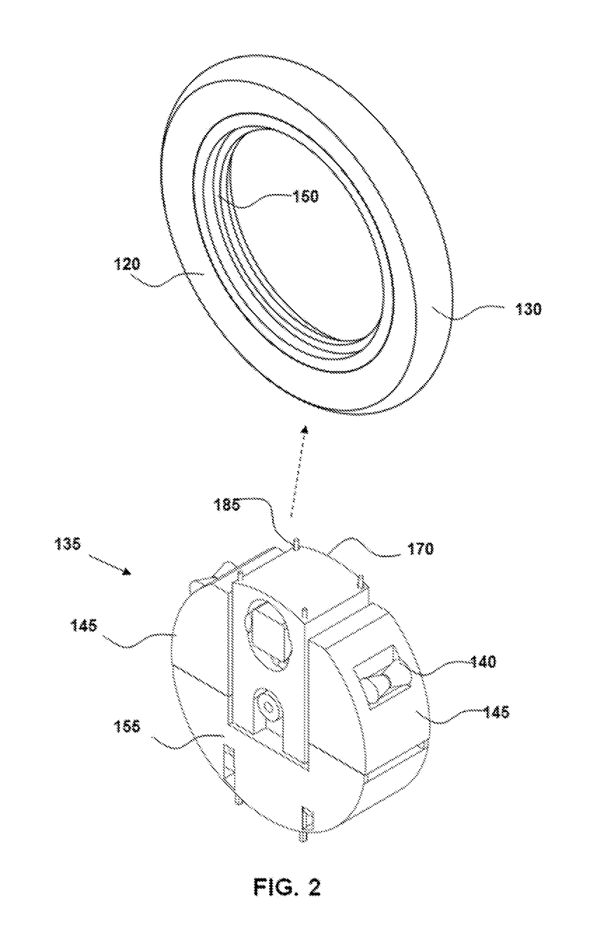

FIG. 1 shows the powered unicycle device 100 with a casing 110 in a closed configuration so that it encases a single wheel 120. In this particular example, the casing 110 is formed from a first, upper portion 110A that covers the top (uppermost) half of the wheel 120, and a second, lower portion 110B that covers the bottom (lowermost) half of the wheel 120. FIG. 2 illustrates an exploded view of components internal to the casing 110, namely a wheel 120 and drive arrangement 135.

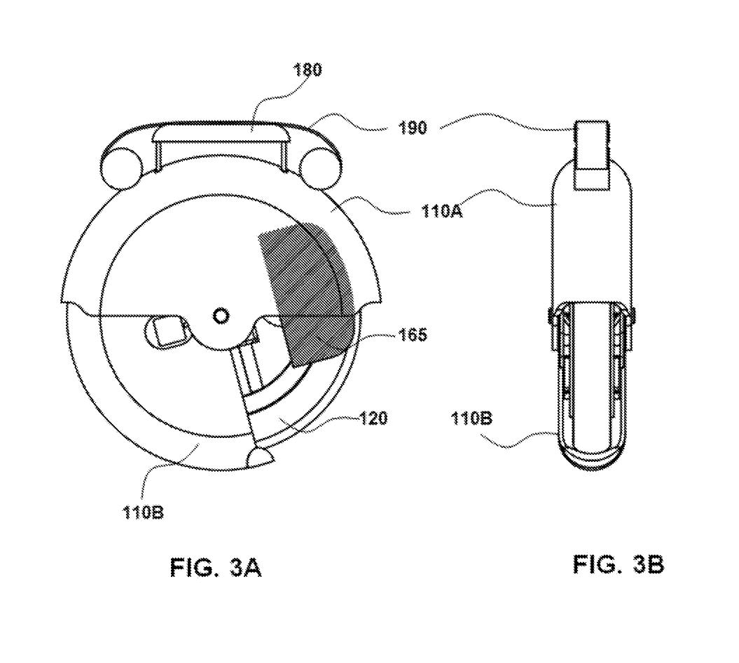

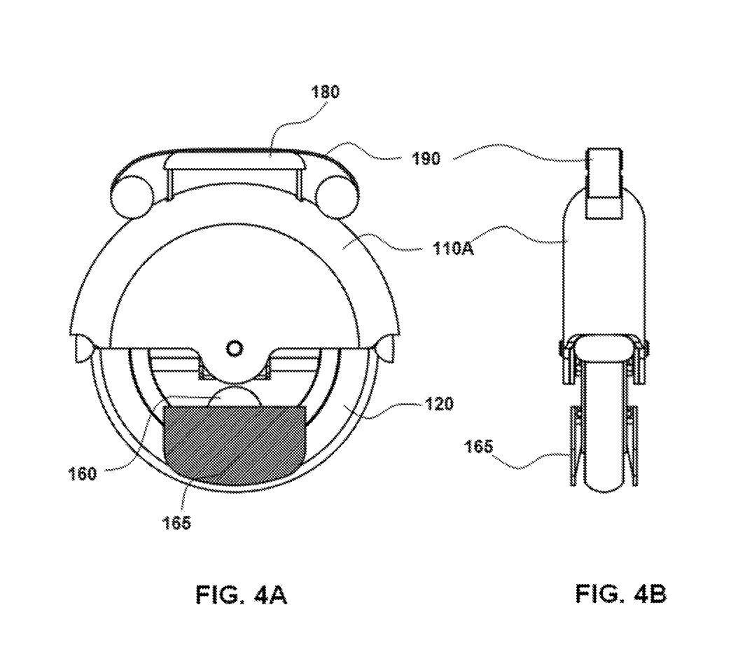

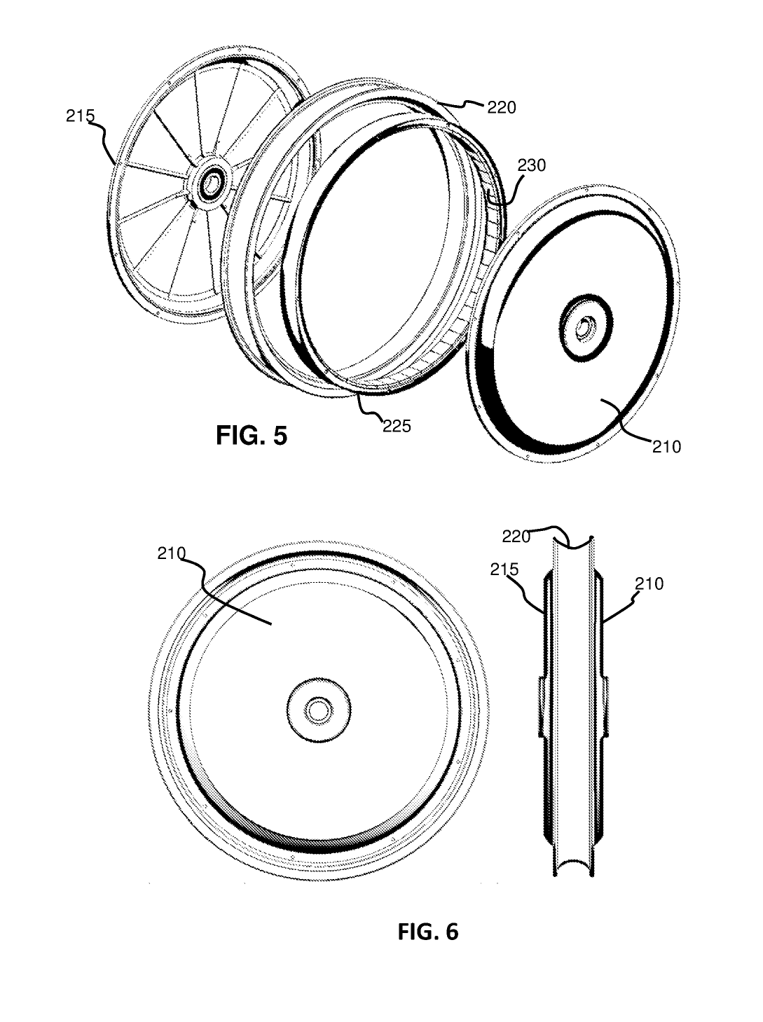

Referring back to FIG. 1, the wheel 120 spins about a central axis 125. The first, upper portion 110A of the casing is retained in a fixed position relative to the central axis 125, whereas the second, lower portion 110B of the casing is adapted to rotate about the central axis 125. Rotation of the second lower portion 110B about the central axis 125 moves the casing between closed and open configurations (as illustrated by FIGS. 3-4). In the closed configuration (shown in FIG. 1), the casing 110 encloses the wheel 120 so that the outer rim 130 of the wheel 120 is not exposed. In the open configuration (shown in FIG. 5), the outer rim 130 of the wheel 120 is exposed so that it can contact a ground surface.

Referring now to FIG. 2, rotation of the single wheel 120 is driven by a drive arrangement 135. The drive arrangement 135 includes guide wheels 140 attached to an outwardly facing side of respective batteries 145. In this example, there are two pairs of guide wheels 140, wherein the two guide wheels in each pair share the same axis of rotation (e.g. by sharing the same axle) and are positioned spaced apart to provide a gap between the two guide wheels.

A rib 150 is provided around the inner rim of the wheel 120 and fits into the gap between the two guide wheels 140 in each pair. The guide wheels 140 are therefore adapted to contact with the inner rim of wheel 120 where they spin along with wheel 120 and hold wheel 120 in place by way of the rib 150. Of course, it will be appreciated that other arrangements, including those with only one guide wheel per battery 145, are possible.

The batteries 145 are mounted on a motor 155 which drives a drive wheel 160 (shown in FIG. 4) positioned at the lowermost point along the inner rim of the wheel 120. The batteries 145 supply power to motor 155 and, this example, there are two batteries in order to create a balanced distribution of volume and weight. However, it is not necessary to employ two batteries 145. Also, alternative energy storage arrangements may be used, such as a flywheel, capacitors, and other known power storage devices for example.

The drive wheel 160 is adapted to contact the inner rim of the wheel 120. The drive wheel 160 for example comprises a wide roller with a groove in the center into which the rib 150 fits. By way of contact with the inner rim of the wheel 120, the drive wheel 160 transmits torque from the motor 155 to the wheel 120. It will be understood that this drive system operates by friction and it may be preferable to avoid slippage between the drive wheel 160 and the inner rim of wheel 120. Positioning the drive wheel 160 at the lowermost point enables the weight of a user to provide a force which presses the drive wheel 160 against the inner rim of the wheel 120, thereby helping to reduce or avoid slippage.

Referring to FIGS. 3 and 4, two foot platforms 165 are coupled to the second, lower portion 1106 of the casing 110, with one on each side of wheel 120. In the open configuration, the foot platforms 165 are movable between a stowed configuration, wherein the foot platforms are substantially parallel with the plane of the wheel (as shown in FIG. 4), and an active configuration, wherein the foot platforms are substantially perpendicular to the plane of the wheel so as to support a user's weight. Thus, in this example, the foot platforms 165 are movable between: (i) a stowed configuration wherein they are flat against the side of the wheel and can be rotated (with the second, lower portion 1106 of the casing) about the central axis 125 so as to be positioned inside (and covered by) the first, upper portion 110A of the casing; and (ii) an active configuration, wherein they project outwardly from the side of the wheel to provide a support surface for the feet of a user (not shown).

Accordingly, the foot platforms 165 are upwardly foldable into a stowed configuration that narrows the profile of the unicycle 100 to aid in storage and carrying. In use, the foot platforms are moved to the active configuration, and the user stands with one foot on each platform 165.

The drive arrangement 135 includes a gyroscope or accelerometer system 170 which it senses forward and backward tilt of the device in relation to the ground surface and regulates the motor 155 accordingly to keep the device upright. In this way, the user is provided a way of controlling the acceleration and deceleration of the unicycle by varying the pressure applied to various areas of the foot platforms 165. It also enables the unicycle to self-regulate its balance in the fore-and-aft plane.

When not in use, the foot platforms 165 are moved to the stowed configuration and then rotated (with the second, lower portion 1106 of the casing) about the central axis 125 so as to move the casing to the closed configuration. Thus, in the closed configuration, the foot platforms 165 are stored inside the casing (covered by the first, upper portion 110A of the casing).

The example shown also comprises a lifting handle 180 coupled to the drive arrangement 135 via a plurality of rods 185. The lifting handle 180 is positioned at the top of the casing 110, above the wheel 120, and may be used to hold the unicycle 100 above the ground, for example to enable a user to lift, carry, convey or place the unicycle 100.

A retractable carrying strap 190 is also provided and attached to the top of the casing 100. The carrying strap 190 may be used to carry the unicycle 100, for example over the shoulder of user. A hook may be provided on the bottom of the case to create rucksack-like belts from the carrying strap 190.

In one example, the handle 180 is also adapted to trigger an activating system which moves the casing between the closed and open configurations. The lifting handle 180 may thus be used to initiate the activating system and move the casing from the closed configuration to the open configuration. Thus, when a user holds the unicycle 100 by the handle above the ground, the force of the unicycle pulling downwards under the influence of gravity causes upward movement of the lifting handle 180 relative to the casing 110 which triggers the activating system. In response to this trigger, the activating system moves the casing to the open configuration (depicted in FIG. 4) so that the lowermost portion of the wheel is exposed and can be brought into contact with a ground surface. In other words, when lifted by the lifting handle 180, the unicycle may be arranged in an open configuration ready for deployment (e.g. placement on a ground surface).

Further, when placed on the ground, the depression of the handle in a downward/inward direction (towards the centre of the wheel 120) moves the rods 185 and causes the foot platforms to move from the stowed configuration (shown in FIG. 4) to the active configuration. Downward movement of the rods causes the foot platforms 165 to rotate about an axis and the rods then hold the foot platforms 165 in place to support the feet of user.

When the user no longer desires to use the unicycle, the user pulls on the lifting handle to lift the unicycle from the ground. This results in upward movement of the lifting handle 180 and the associated rods 185 relative to the casing 110 which then causes the foot platforms to move from the active configuration to the stowed configuration.

The design described above has a static wheel hub. The motor arrangement drives the drive wheel at the bottom of the device and this drives the wheel around the static hub. This design has a relatively large number of components. For example, there are different components for centering the wheel around the outside of the central hub and for driving the wheel, and there are multiple rotating parts between the motor and the wheel.

A design which may employ fewer components forms the wheel directly as the rotor of the motor. This is a so-called hub motor. Thus, the hub contains the motor stator and the wheel rim itself comprises permanent magnets which define the motor rotor. In such a design, there are fewer rotating parts and the alignment of the rotor automatically provides alignment with the wheel hub.

This invention is of particular interest for this type of design and relates specifically to the design of the outer casing around the central motor.

FIG. 5 shows a basic design. The motor is enclosed in a cylindrical inner volume as in the example above. This volume is closed by first and second side walls 210, 215 and a central annular rim 220. The central rim has a larger diameter and it defines the wheel rim base and side flanges. The rotor of the motor comprises a cylindrical carrier 225 on which an array of permanent magnets 230 is carried.

The two side walls 210, 215 are clamped together with the carrier 225 sandwiched between. Coupling bolts or screws pass through the carrier 225 so that the rotor 225,230 and the two side walls define a rotating wheel hub. The wheel rim 220 sits around the outside of the rotor 225,230. It is fixed to the rotor 225,230.

FIG. 6 shows the assembled wheel hub in side view and end view. This design has three components to form the outer casing. Furthermore, if a user wishes to make removal of the tyre easier to achieve, the only option is to dismantle the whole assembly. This exposes the rotor and the internal motor components to the outside.

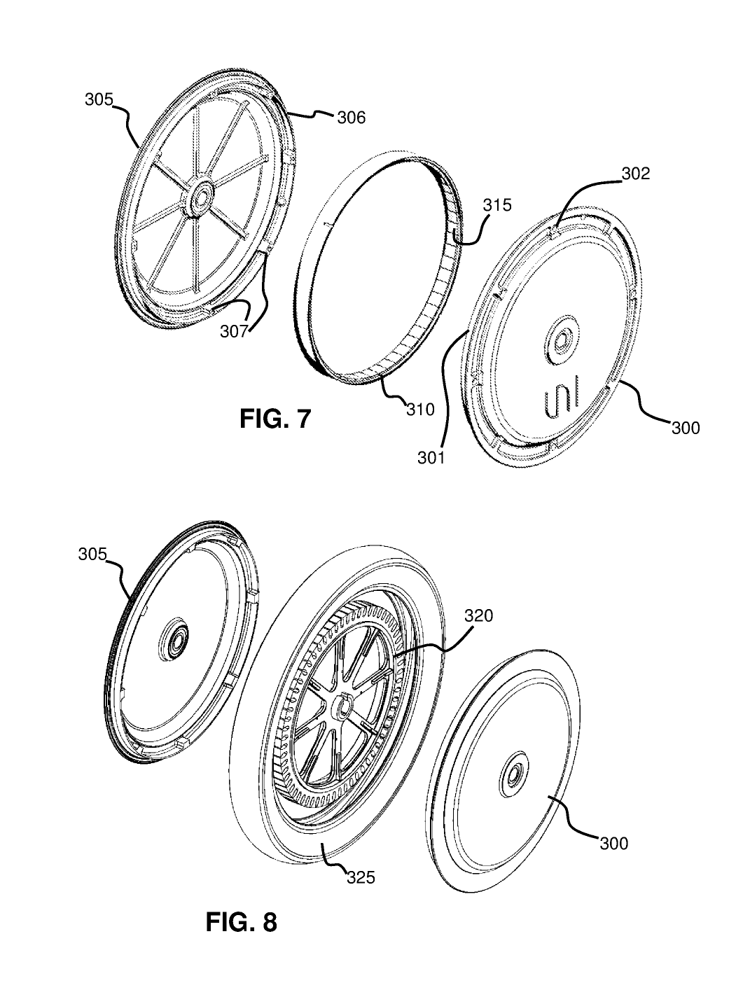

FIG. 7 shows a design in accordance with an example of the invention, in exploded form. The motor outer casing comprises first and second side walls 300,305. Each of these may be a single integrated piece (as shown) or it may be a sub-assembly of components.

These two components together define the two side plates and also the outer annular rim. The wheel is again mounted around the outer annular rim, and the motor rotor, which again comprises a carrier 310 and an array of magnets 315, is mounted within the outer annular rim. The first side wall 300 has a rim portion 301 and the second side wall 305 has a rim portion 306. The side walls 300, 305 are coupled together with the rim portions 301, 306 in contact with each other thereby together defining the outer annular rim.

The rim portions may be considered to comprise the annular part which spans between the side walls but also the radially outermost part of the side wall. This radially outermost part of the side wall forms the lateral retaining parts of the wheel rim.

The first and second side walls can be identical in shape. In this way, there is a single component design for the two casing halves.

Each side wall 300,305 comprises a set of tabs 302, 307 around the inner periphery of the rim portion. These tabs are positioned over the outer periphery of the rotor 310. The rotor and the rim are coupled together by any suitable means, with no permitted relative movement. Thus, the rotor of the hub motor directly forms the wheel hub.

The side walls 300, 305 are connected together at the tabs 302, 307.

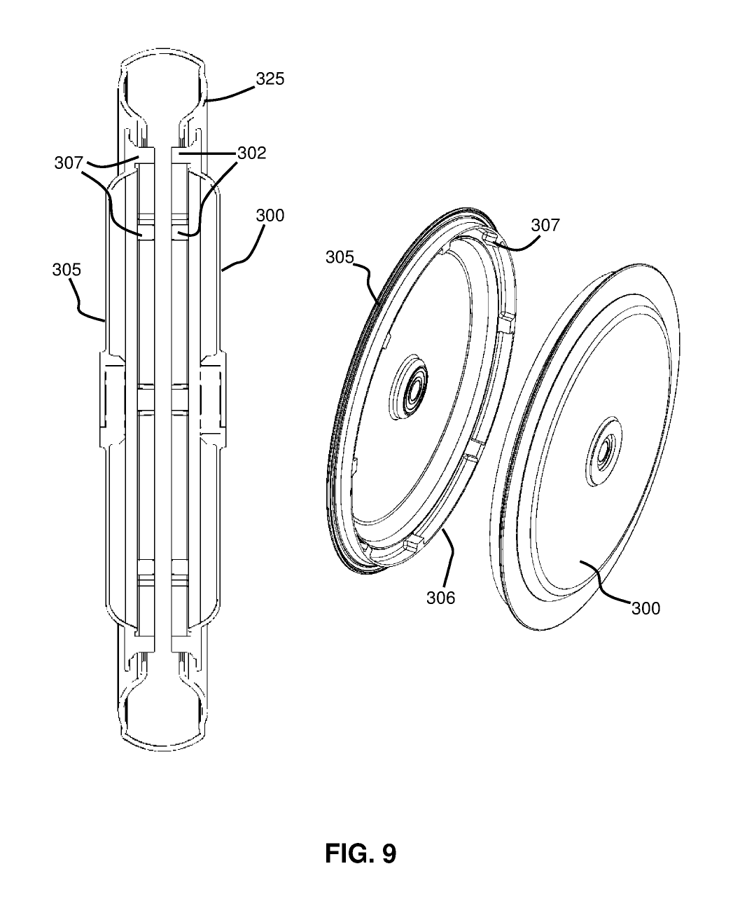

FIG. 8 shows the central stator 320 and the tyre 325. FIG. 9 shows the tabs 307 of the side wall portions more clearly, and shows a perspective view of the side wall portions as well as a cross section through the side wall portions and the tyre with the side wall portions slightly separated.

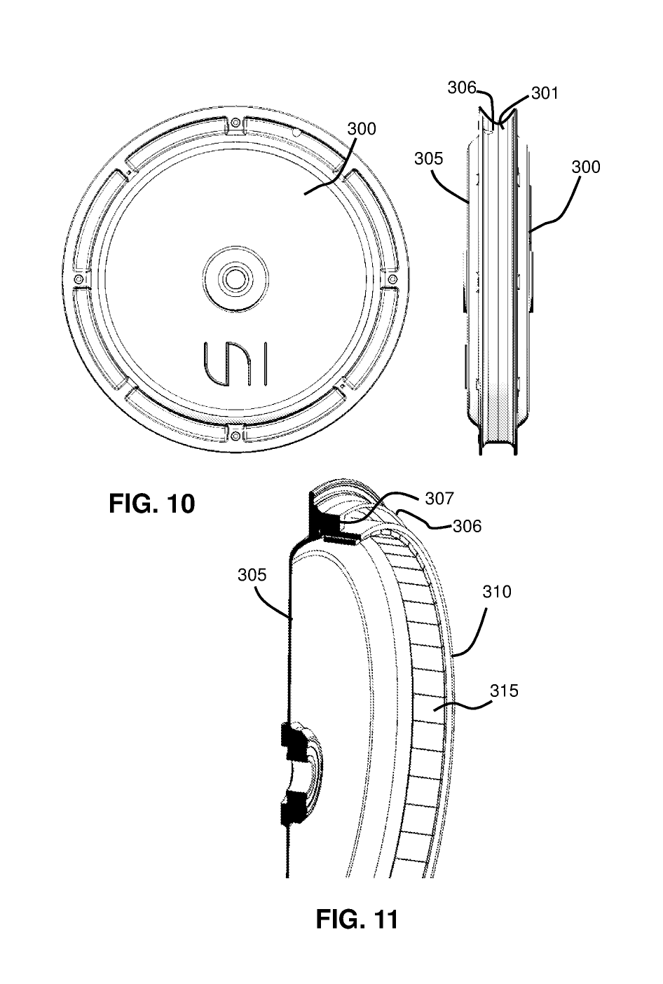

FIG. 10 shows the closed casing in side view and end view, and shows how each side wall portion forms half of the wheel rim.

FIG. 11 shows more clearly how the outer surface of the rotor, in particular the outer surface of the carrier 310, is against the tabs 307 to provide alignment.

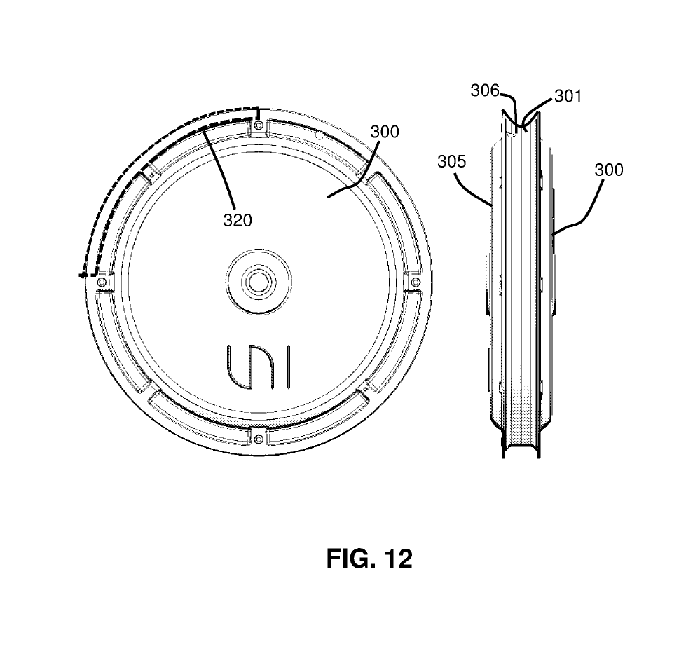

The examples above show the side walls as individual components. However, the rim portion of the side wall may be separable from the side plate part. In a particularly advantageous example, a portion of the rim portion can be removed from the side wall (leaving the side plate in place). This idea is shown in FIG. 12.

A portion 320 of the rim portion is removable from the remainder of the side wall, while maintaining the side wall plates connected together. This creates a gap in the outer edge of the side wall of the rim to assist lateral initial removal of the tyre at that location. However, the side wall plates remain in place so that the motor enclosure is still closed. The magnet ring of the rotor does not need to be interfered with.

In FIG. 12, only a portion of the rim (and by rim is meant a radial outer portion of the circular plate as well as an associated portion of the cylindrical base (301 or 306) of the wheel rim) is detachable. However, the compete annulus defining the rim portion may be removed so that the tyre can be slid laterally off the hub. Again, the side plates maintain a closed enclosure for the motor.

Many of the features described above with reference to FIGS. 1-4 are optional. The retractable housing around the wheel is entirely optional as is the particular handle arrangement shown and the automated operation of the food pedals.

In the example above, the rotor is a continuous ring. However, it may be formed as two ring portions, one of which is mounted to one side casing component and the other of which is mounted to the other side casing component. There may then be two identical sub-assemblies, each sub-assembly being one side wall and half of the rotor.

Similarly, the side walls may be in multiple parts, including with removable rim portions as shown in FIG. 12.

In the example shown, the magnets are attached to a carrier. The magnets are arranged with alternating polarity, and the carrier is ferromagnetic. They may instead be attached directly to the side walls if a suitable material is used for the side walls, for example in recesses formed in the rim portions. Thus, the carrier may not be needed, because the casing side walls may act as the carrier and the conduit for the magnetic flux of the magnets.

The device has a single hub motor. Typically, a single tyre is attached to the hub to form the wheel, but there may be two or more tyres side by side, but essentially still forming a single wheel, i.e. still defining a unicycle.

The hub motor design has been shown used in a powered unicycle device. However, the hub motor may be used in any other application where exising hub motors are used. Some examples assist in tyre changing and others enable weight reductions to be achieved. These advantages are not limited to powered unicycle devices.

While specific embodiments have been described herein for purposes of illustration, various modifications will be apparent to a person skilled in the art and may be made without departing from the scope of the invention.

1. A hub motor for driving a wheel, wherein the hub motor comprises:
a motor casing around an inner part of the motor, wherein the motor casing defines side walls and an outer annular rim,
wherein the motor casing comprises a first side wall and a second side wall, each side wall comprising a rim portion, wherein the side walls are coupled together with the rim portions in contact with each other thereby together defining the outer annular rim.

2. The hub motor as claimed in claim 1, comprising an inner stator and an outer rotor, and the outer rotor is mounted within the outer annular rim.

3. The hub motor of claim 1, wherein the first and second side walls are identical in shape.

4. The hub motor of claim 1, wherein each side wall comprises an integral side wall plate and rim portion.

5. The hub motor of claim 1, wherein each side wall comprises a side wall plate and the rim portion, and the rim portion or a section of the rim portion is removable from a remainder of the side wall.

6. The hub motor of claim 1, wherein at least one of the side walls comprises a set of tabs around an inner periphery of the rim portion.

7. The hub motor of claim 6, wherein the side walls are connected together at the tabs.

8. The hub motor of claim 1, comprising an outer rotor which comprises a cylindrical carrier on which an array of permanent magnets is mounted.

9. The hub motor of claim 1, comprising an inner stator which comprises an electromagnet coil arrangement.

10. The hub motor of claim 1, further comprising a tyre around the annular outer rim.

11. A powered unicycle device, comprising:
a hub motor as claimed in claim 1; and
a balance control system configured to maintain fore-aft balance of the unicycle device.

12. (canceled)
